(19) United States
(12) Patent Application Publication
(10) Pub. No.: US 2020/0034406 A1
(43) Pub. Date: Jan. 30, 2020

(54) REAL-TIME DATA AGGREGATION

(71) Applicants: Alejandro Abdelnur, Barcelona (ES); Harikiran Nayak, San Francisco, CA (US)

(72) Inventors: Alejandro Abdelnur, Barcelona (ES); Harikiran Nayak, San Francisco, CA (US)

(21) Appl. No.: 16/046,466

(22) Filed: Jul. 26, 2018

(51) Int. Cl. G06F 17/18

(52) U.S. Cl. CPC G06F 17/18

(57) ABSTRACT

In various example embodiments, a system, computer-readable medium and method to aggregate data from multiple data streams according to an aggregation function. The data streams are received and partitioned according to consecutive extraction time windows. For each extraction time window, and for each received data stream, at least one aggregatable value is computed, the aggregatable value being computed based on the values of the records of the data stream having a timestamp that is included in the extraction time window. The at least one aggregatable value is stored in association with the extraction time window. A consolidated aggregation value is computed by applying a consolidation function on the aggregatable values stored in association with the extraction time windows included in a consolidation time window.

### TECHNICAL FIELD

The subject matter disclosed herein generally relates to the technical field of special-purpose machines that provide for real-time data aggregation, comprising software-configured computerized variants of such special-purpose machines and improvements to such variants, and to the technologies by which such special-purpose machines become improved compared to other special-purpose machines that provide for real-time data aggregation.

### BACKGROUND

An aggregate function is a function where the values of multiple records are grouped together to form a single value of more significant meaning. Common aggregate functions include: Average( ) (i.e., arithmetic mean), Count( ) Maximum( ) Median( ) Minimum( ) Mode( ) and Sum( ) As an example, an SQL query that obtains the number of residents per state as well as their average age would be: SELECT state, COUNT(*), AVG(age) FROM resident GROUP BY state Performing some of these aggregation functions on real-time data is referred as data metrics. Conventional data metrics methods are limited to a single data source.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a computer system, within which one example embodiment of a data aggregator may be deployed, according to an example embodiment.

FIG. 2 is a block diagram showing example components of a data aggregator, according to some embodiments.

FIG. 3 is a flowchart illustrating an example method for aggregating data from multiple data streams, according to an example embodiment.

FIG. 4 is a data flowchart of the example embodiment of FIG. 3

FIG. 5 is a detailed data flowchart illustrating an example method for aggregating data from multiple data streams with a rolling consolidation time window, according to an example embodiment.

FIG. 6 is a detailed data flowchart illustrating an example method for aggregating data from multiple data streams with a sliding consolidation time window, according to another example embodiment.

FIG. 7 shows a diagrammatic representation of a machine in the example form of a computer system within which a set of instructions, for causing the machine to perform any one or more of the methodologies discussed herein, may be executed.

The headings provided herein are merely for convenience and do not necessarily affect the scope or meaning of the terms used.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

According to conventional data metrics methods, all the data received is stored in a database, so that any aggregation function can be performed on the stored data at a later point. This is expensive in terms of storage space and soon becomes impossible as the quantity of data received grows. In particular, conventional data metrics methods are inadequate to deal with extremely large data sets (e.g., Big Data sets). To mitigate this issue, some conventional data metrics methods aggregate data in real time and store only the result of the aggregation. However, these conventional data metrics methods do not allow for a consolidation of the aggregated data across multiple data sources. Indeed, the result of the aggregation of each data source is not sufficient to compute a consolidated aggregation value across all the data sources. As an example, the average value computed for each data source is not sufficient to compute the consolidated average value across all the data sources. Performing an average of the average values computed for all the data sources would not provide a reliable consolidated average value because the average values computed for all the data sources were not necessarily computed based on the same number of records.

A system, a non-transitory computer-readable storage medium storing instructions, and a computer-implemented method described herein are directed to a data aggregator. The data aggregator accesses data streams, each data stream including a sequence of records, each record including a record value and a timestamp. The data aggregator partitions the data streams according to consecutive extraction time windows. For each extraction time window, and for each received data stream, the data aggregator computes, at least one aggregatable value, the aggregatable value being computed based on the values of the records of the data stream having a timestamp that is included in the extraction time window, and stores the at least one aggregatable value in association with the extraction time window. The at least one aggregatable value constitutes the minimum data that needs to be extracted from the data streams to be able to compute a consolidated aggregation value, the consolidated aggregation value being the result of an aggregation function across the multiple data streams. The data aggregator then computes the consolidated aggregation value by applying a consolidation function on the aggregatable values stored in association with the extraction time windows included in a consolidation time window.

The data aggregator constitutes an improvement to computer functionality. In particular, the data aggregator aggregates data across multiple data streams with improved computational efficiently in terms of computational resources used (e.g., time and storage). The computation of the consolidated aggregation value is a low complexity computation since the aggregatable values have already been extracted from the data streams. In addition, the retrieval of the aggregatable values is also a low complexity step because the aggregatable values have been stored in association with the corresponding extraction time window. Therefore, the data aggregator improves the way the processor extracts aggregatable values from the data streams, stores the aggregatable values and retrieves the aggregatable values to compute the consolidated aggregation value, thereby aggregating data from multiple data streams, with improved computational efficiency in terms of time required. Moreover, the data aggregator only stores the aggregatable values, as opposed to conventional data metrics methods according to which all the received data must be stored. Therefore, the data aggregator aggregates data across multiple data streams with improved computational efficiently in terms of space used.

Moreover, the data aggregator can perform real-time computations of aggregate function that could not have been performed by conventional data metrics methods. For example, conventional methods could not compute an average over multiple data streams in real-time. Indeed, according to conventional methods, an average value would be computed for each data stream in real-time and the average values would be stored. However, an average computed for each data stream is not sufficient to compute a consolidated average across all the data streams. Performing an average of the average values computed for all the data streams would not provide a reliable consolidated average value because the average values computed for all the data streams were not necessarily computed based on the same number of records. Moreover, the data aggregator can implement a data time decay while conventional data metrics methods do not allow to implement a data time decay.

It is understood that various embodiments further include encoded instructions that comprise operations to generate a user interface(s) and various user interface elements. The user interface and the various user interface elements can be displayed to be representative of data streams, aggregatable values, consolidated aggregation value, time windows, etc.

It is understood that various embodiments include the generation of one or more modules that comprise source code that, when compiled by a computing device(s), creates object code that causes the computing device(s) to perform one or more operations described herein. In other embodiments, any of the modules comprise object code that causes the computing device(s) to perform various operations described herein. In some embodiments, each module(s) can be permanently configured circuitry, such as ASICs, etc. In various embodiments, all operations of the data aggregator can be performed by a computer system, or computer module(s), or software modules situated between subsystems of a pipeline, such that the data aggregator accesses records being transmitted between the subsystems.

Other embodiments include the generation of one or more modules that comprise source code that, when compiled by a server computing device(s), creates object code that causes the server computing device(s) to perform one or more operations described herein in communication with one or more client computing devices. In other embodiments, any of the modules comprise object code that causes the server computing device(s) to perform various operations described herein in communication with the one or more client computing devices.

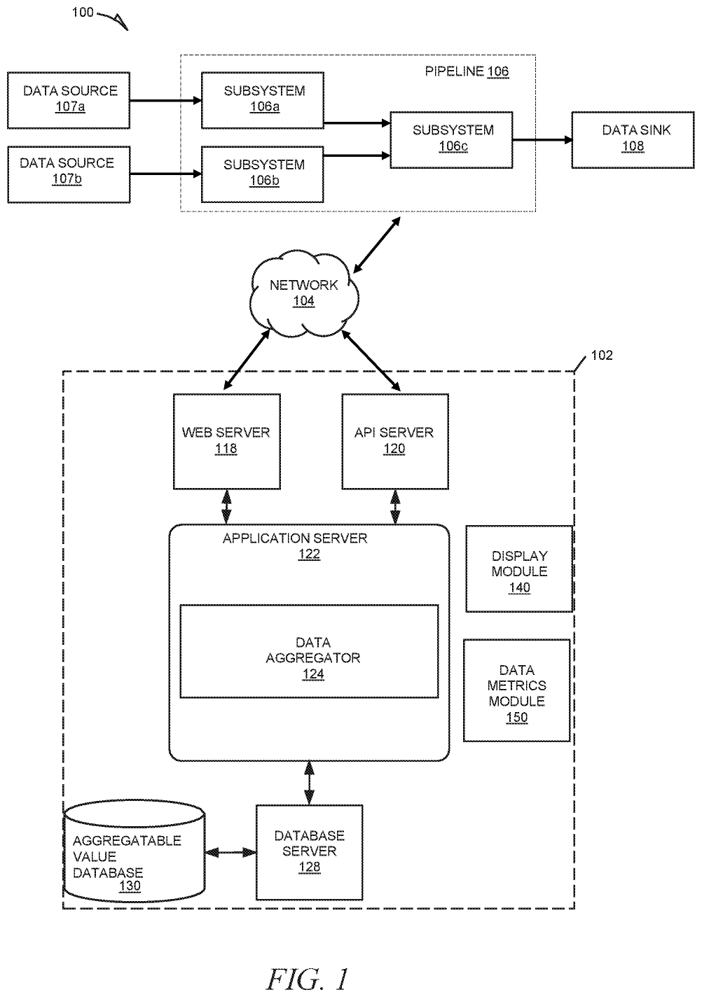

Turning now to FIG. 1, FIG. 1 is a network diagram depicting a computer system 100, within which one example embodiment of a data aggregator 124 may be deployed, according to some embodiments of the invention. A data pipeline 106 is a set of one or more coupled subsystems 106a-106c that process data streams received from data source(s) 107a-107b and provide processed data streams to data sink(s) 108. Data sources may include telecommunications systems, data management systems, sensor networks, and any other system that produce data (in particular real-time data, and/or non-continuous data to be processed in batch data processing). Each subsystem 106a-106c processes one or more input data stream(s), and forward one or more output data stream(s) to one or more downstream subsystem(s) 106c or to one or more data sink(s) 108. A data stream is an unbounded flow of data records (“records”). A record associates data field values with corresponding data types defined according to a database schema.

A networked system 102, in the example, provides server-side functionality, via a network 104 (e.g., the Internet or Wide Area Network (WAN)) to the data pipeline 106. FIG. 1 illustrates, for example, an Application Program Interface (API) server 120 and a web server 118 are coupled to and provide programmatic and web interfaces respectively to an application server(s) 122. The application server 122 hosts a data aggregator 124. The application server 122 is, in turn, shown to be coupled to a database server 128 that facilitates access to an aggregatable value database 130, which stores aggregatable values computed by the data aggregator 124. In other embodiments, the data aggregator 124 can be coupled to an aggregatable value cache, which stores the aggregatable values computed by the data aggregator 124.

While the data aggregator 124 is shown in FIG. 1 to form part of the networked system 102, it will be appreciated that, in alternative embodiments, the data aggregator 124 may form part of a service that is separate and distinct from the networked system 102. The data aggregator 124 could also be implemented as part of one or more of the subsystems 106a-106c.

Further, the computer system 100 is of course not limited to such an architecture as shown in FIG. 1, and could equally well find application in a distributed, or peer-to-peer, architecture system, for example. Any portion, or portions, of the data aggregator 124 may reside and be executed from any kind of computing device. The data aggregator 124 could also be implemented as standalone software program(s), which does not necessarily have networking capabilities.

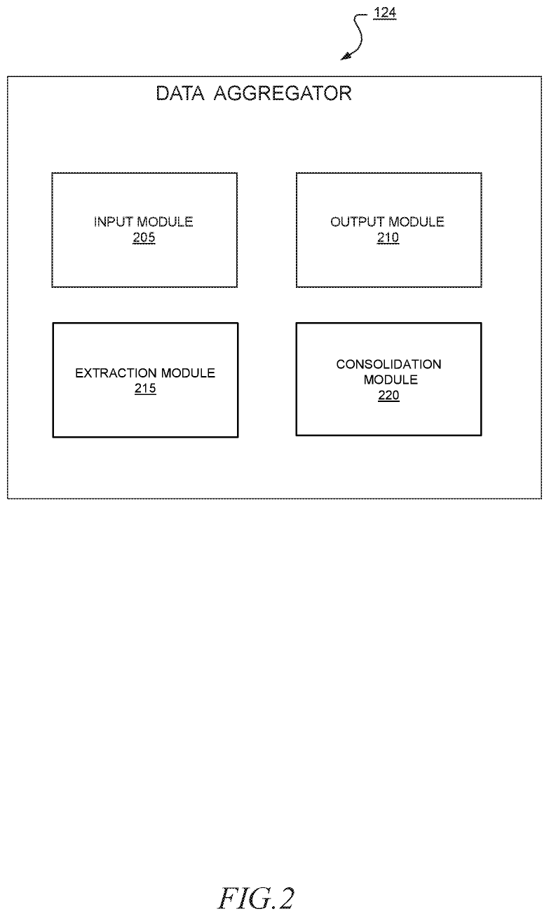

FIG. 2 is a block diagram showing example components of the data aggregator 124, according to some embodiments. The data aggregator 124 may include an input module 205, an output module 210, an extraction module 215, and a consolidation module 220.

The input module 205 controls, manages and stores information related to any inputs from one or more components of the system 102 as illustrated in FIG. 1. In various embodiments, the input module 205 controls, manages and stores input or output data stream(s) from subsystems 106a-106c. The input module 205 further accesses instructions at the API server 120 or at the web server 118 using a web API. The instructions include at least an aggregation function to be performed, and may further include a consolidation window type and time, an extraction window type and time, and/or a time zone. The extraction window type and time determines the extraction time windows used by that the data aggregator 124 to compute aggregatable values. The consolidation window type and time determines the consolidation time windows used by that the data aggregator 124 to compute the consolidated aggregation values. The consolidation window type and time also determines how the data aggregator 124 generates charts and events. The instructions may further include a filter expression and instructions to filter the received data streams and compute the aggregatable values based on the filtered data streams, and/or a “group by” expression and instructions to group the received data streams and compute the aggregatable values based on the grouped data streams.

The output module 210 controls, manages and stores information related to outputs and sends any outputs to one or more components of a display module 140, or of a data metrics module 150. In some embodiments, the output is data including the consolidated aggregation value, or event records including the consolidated aggregation value.

The extraction module 215 manages, controls, stores, and accesses information related to aggregatable values. For example, the extraction module 215 computes, for each extraction time window, and for each received data stream, at least one aggregatable value. The extraction module 215 stores, in the aggregatable value database(s) 130, the at least one aggregatable value in association with the corresponding extraction time window. In other embodiments, the extraction module 215 is coupled to an aggregatable value cache and stores the aggregatable values in the aggregatable value cache.

The consolidation module 220 manages, controls, stores, and accesses information related to the aggregatable values, and the consolidated aggregation values. The consolidation module accesses the aggregatable values from the database server(s) 128 that facilitates access to the aggregatable value database(s) 130, which stores the aggregatable values. In other embodiments, the consolidation module 220 is coupled to the aggregatable value cache, which stores aggregatable values. For example, the consolidation module 220 computes a consolidated aggregation value by applying a consolidation function on the aggregatable values stored in association with the extraction time windows included in a consolidation time window.

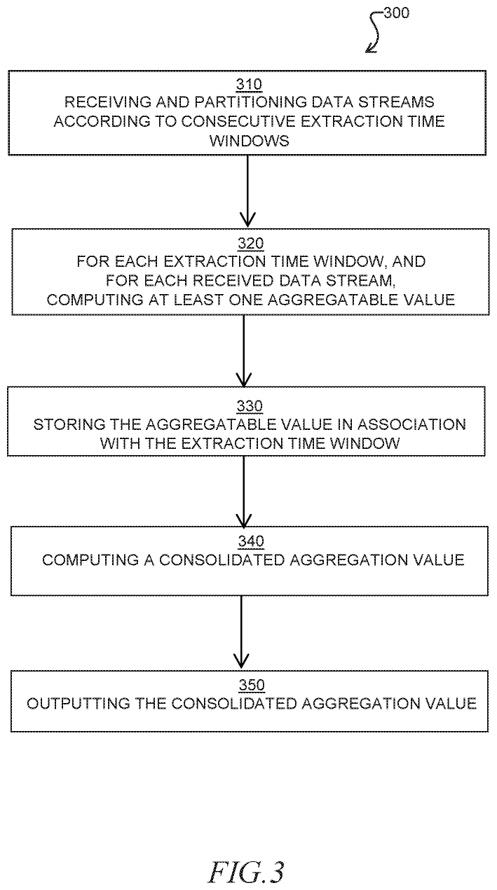

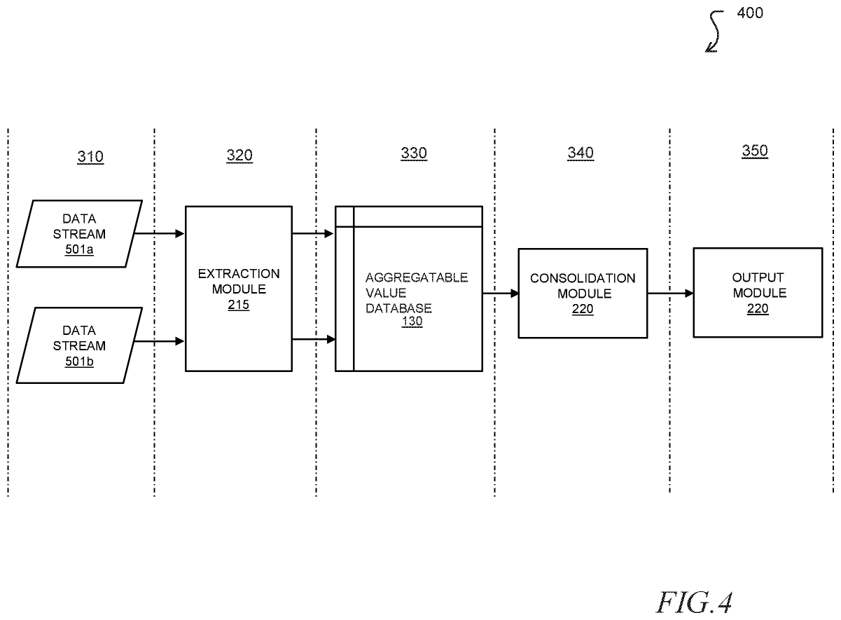

FIG. 3 is a flowchart 300 illustrating an example method for aggregating data from multiple data streams, according to an example embodiment. FIG. 4 is a data flowchart 400 of the example embodiment of FIG. 3.

At operation 310, the input module 205 receives a plurality of data streams. The data streams may in particular be output data streams of some or all of the subsystems 106a-106c. Each data stream including a sequence of records, each record including at least one record value and a timestamp. If the data streams are not synchronized, the input module 205 synchronizes the received data streams based on the time stamps of the records. The input module 205 processes the received data streams in batches, each batch corresponding to an extraction time window. The extraction time windows are rolling time windows, which means that consecutive extracting time windows do not overlap.

At operation 320, at the end of an extraction time window, the extraction module 215 computes, for each received data stream, one or more aggregatable value for the extraction time window. The aggregatable values constitute the minimum data that needs to be extracted from the data streams to be able to compute the consolidated aggregation value. The aggregatable values computed for a specific data stream and a specific extraction time window are computed based on the values of the records of the specific data stream having a timestamp that is included in the specific extraction time window. For example, if the consolidation time window is a one-hour rolling time window, the extraction module 215 computes the aggregatable value(s) every hour on the hour based on the records that have a timestamp that is included in the past hour. Each aggregatable value is reset at the beginning of every extraction time window.

At the end of every extraction time window, the extraction module 215 stores (operation 330), in the aggregatable value database(s) 130, the at least one aggregatable value in association with the extraction time window that includes the timestamp of the record based on which the aggregatable value was computed. Storing the aggregatable values in association with the corresponding extraction time window, makes it possible to compute a consolidated aggregation value at a later point.

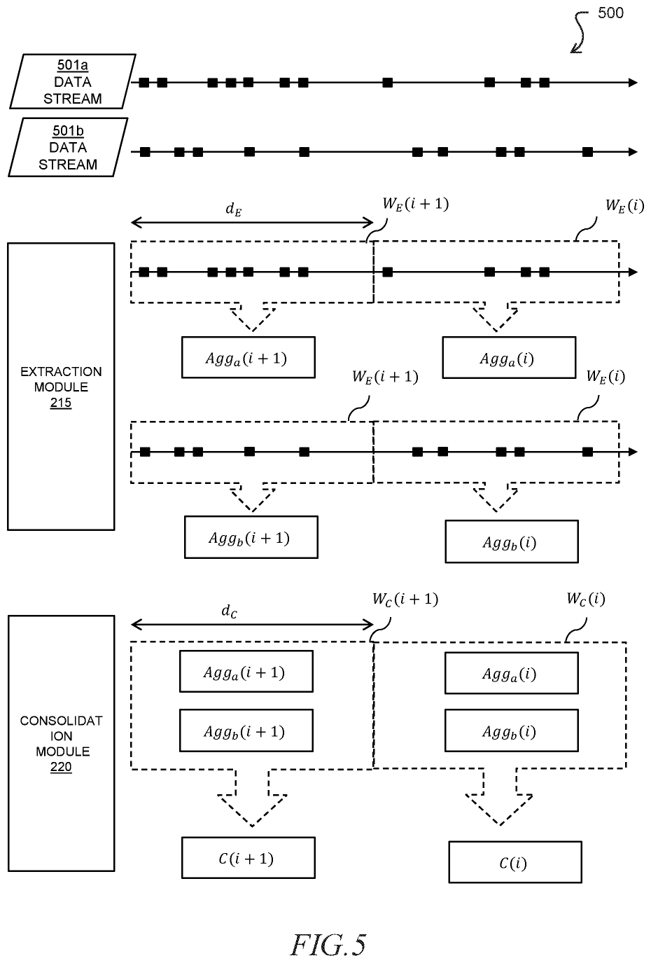

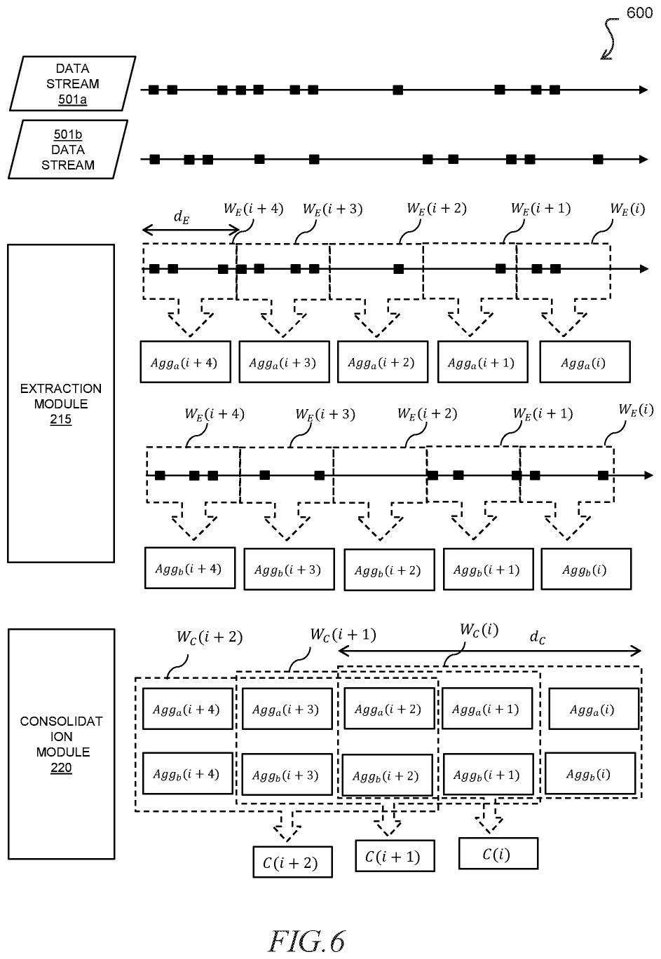

At operation 340, the consolidation module 220 computes a consolidated aggregation value for a consolidation time window by applying a consolidation function on the aggregatable values stored in association with the extraction time windows included in the consolidation time window. The consolidation function is the function that when applied to the aggregatable values provides the result of the aggregation function across all the data streams. The consolidation time window is the time window for which the consolidated aggregation value is computed. A consolidation time window includes one or more consecutive extraction time windows. Example embodiments of the consolidation time window are described in relation to FIGS. 5 and 6.

At operation 350, the output module 210 outputs the consolidated aggregation value. The output module 210 may generate and cause the display of data including the consolidated aggregation value ion the display module 140. For example, the output module 210 may generate and cause the display of a chart representing the consolidated aggregation values in relation to the consolidation time window. The data displayed may include data source identifier(s) of the source(s) of the data stream(s) used to compute the consolidated aggregation value. The output module 210 may also generate event records including the consolidated aggregation values and send the generated event records to the data metrics module 150 for storing or performing any kind of data processing or data analysis. The output module 210 may generate event records that contain all the consolidated aggregation values or generate an event record for each of the consolidated aggregation values. The event record may include a destination to store the event record. The event record may trigger an alert. For example, an event record triggering an alert may be generated when a consolidated aggregation value trespasses a predefined threshold.

FIG. 5 is a detailed data flowchart 500 illustrating an example method for aggregating data from multiple data streams 501a, 501b wherein the consolidation time windows W_{C}(i), W_{C}(i+1) are rolling time windows, which means that consecutive consolidation time windows W_{C}(i), W_{C}(i+1) do not overlap. In FIG. 5, the records for the data streams on the right of the diagram arrive sooner in time and the records on the left of the diagram arriver later in time. Thus, the earlier windows (e.g., W_{E}(i)) are on the right and the later windows (e.g., W_{E}(i+1)) are on the left. Rolling consolidation time windows may be used to generate periodic historic analysis of the data passing through the pipeline 106. In this embodiment, each consolidation time window W_{C}(i), W_{C}(i+1) includes only one extraction time window W_{E}(i), W_{E}(i+1). More precisely, in the illustrated example of FIG. 5, consolidation time window W_{C}(i) includes extraction time window W_{E}(i), and consolidation time window W_{C}(i+1) includes extraction time window W_{E}(i+1). However, it is understood that a consolidation time window W_{C}(i), W_{C}(i+1) could include any fixed number of extraction time windows W_{E}(i), W_{E}(i+1). A duration d_{C} (e.g., 1 hour) of a consolidation time window W_{C}(i), W_{C}(i+1) is a multiple m (in the illustrated example of FIG. 5, m=1) of a duration d_{E} (e.g., 1 hour) of an extraction time window W_{E}(i), W_{E}(i+1). At operation 310, the input module 205 receives a plurality of data streams 501a, 501b. On FIG. 5, each black square represents a record of a data stream. The records are partitioned into batches, each batch corresponding to an extraction time windows W_{E}(i), W_{E}(i+1). At operation 320, the extraction module 215 computes, at the end of extraction time window W_{E}(i), one aggregatable value Aggₐ(i), and Agg_{b}(i) for data stream 501a, and 501b respectively. At operation 330, at the end of extraction time window W_{E}(i), the extraction module 215 stores the aggregatable values Aggₐ(i), Agg_{b}(i) in association with extraction time window W_{E}(i). At operation 340, the consolidation module 220 computes a consolidated aggregation value C(i) for consolidation time window W_{C}(i) by applying a consolidation function on the aggregatable values Aggₐ(i), Agg_{b}(i). The consolidated aggregation value is reset at the beginning of extraction time windows W_{E}(i+1), and operations 320-340 are repeated for extraction time windows W_{E}(i+1) and consolidation time window W_{C}(i+1).

FIG. 6 is a detailed data flowchart 600 illustrating an example method for aggregating data from multiple data streams 501a, 501b, wherein the consolidation time windows W_{C}(i), W_{C}(i+1), W_{C}(i+2) are sliding time windows, which means that consecutive consolidation time windows W_{C}(i), W_{C}(i+1), W_{C}(i+2) overlap. Sliding consolidation time windows may be used to provide real-time information about the data streams passing through the pipeline 106. In this embodiment, the extraction time windows W_{E}(i), W_{E}(i+1), W_{E}(i+2), W_{E}(i+3), W_{E}(i+4) are rolling time windows, but the consolidation time windows W_{C}(i), W_{C}(i+1), W_{C}(i+2) are sliding time windows, each consolidation time window W_{C}(i), W_{C}(i+1), W_{C}(i+2) including a fixed number (in the illustrated example of FIG. 6) of consecutive extraction time windows W_{E}(i), W_{E}(i+1), W_{E}(i+2), W_{E}(i+3), W_{E}(i+4). Consequently, consecutive sliding time windows overlap. More precisely, in the illustrated example of FIG. 6, consolidation time window W_{C}(i) includes extraction time windows W_{E}(i), W_{E}(i+1), W_{E}(i+2), consolidation time window W_{C}(i+1) includes extraction time windows W_{E}(i+1), W_{E}(i+2), W_{E}(i+3), and consolidation time window W_{C}(i+2) includes extraction time windows W_{E}(i+2), W_{E}(i+3), W_{E}(i+4). The duration d_{C} (e.g., 1 hour) of a consolidation time window W_{C}(i), W_{C}(i+1), W_{C}(i+2) is a multiple m (e.g., m=60) of the duration d_{E} (e.g., 1 minute) of an extraction time window W_{E}(i), W_{E}(i+1), W_{E}(i+2), W_{E}(i+3), W_{E}(i+4). At operation 310, the input module 205 receives a plurality of data streams 501a, 501b. On FIG. 6, each black square represents a record of a data stream. The records are partitioned into batches according to rolling extraction time windows W_{E}(i), W_{E}(i+1), W_{E}(i+2), W_{E}(i+3), W_{E}(i+4). At operation 320, the extraction module 215 computes, at the end of extraction time window W_{E}(i), one aggregatable value Aggₐ(i), and Agg_{b}(i) for data stream 501a, and 501b respectively. At operation 330, at the end of extraction time window W_{E}(i), the extraction module 215 stores the aggregatable values Aggₐ(i), and Agg_{b}(i). Operations 320 and 330 are repeated for extraction time windows W_{E}(i+1), W_{E}(i+2). At operation 340, at the end of consolidation time window W_{C}(i), the consolidation module 220 computes a consolidated aggregation value C(i) by applying the consolidation function on the aggregatable values Aggₐ(i), Agg_{b} (i), Aggₐ(i+1), Agg_{b} (i+1), Aggₐ(i+2), Agg_{b} (i+2) stored in association to them (in the illustrated example of FIG. 6, m=3) last extraction time windows W_{E}(i), W_{E}(i+1), W_{E}(i+2). The consolidated aggregation value is reset at the beginning of extraction time windows W_{E}(i+3), and operations 320-340 are repeated for extraction time windows W_{E}(i+3) and consolidation time window W_{C}(i+1). If d_{C} equal to 1 hour and d_{E} equal to 1 minute, m is equal to 60, and the consolidation module 220 computes the consolidated aggregation value by applying the consolidation function on the aggregatable values stored in association with the last 60 1-minute extraction time windows.

The consolidated aggregation value C(i) may be computed without weighting the aggregatable values (i.e., the weight given to each aggregatable value is the same, regardless of the age of the extraction time window it is associated to). Alternatively, the aggregatable values may be weighted based on the age of the extraction time window they are associated to (e.g., aggregatable values associated to more recent extraction time windows are given a higher weight that aggregatable values associated to less recent extraction time windows). For example, the aggregatable values can be multiplied by a time decay ratio (e.g., linear, or exponential to the age of the extraction time window or based on any other time decay function).

The consolidation module 220 may compute the consolidated aggregation value for a consolidation time window by applying a consolidation function on all the aggregatable values stored in association with all the extraction time windows included in the consolidation time window. Alternatively, the consolidation module 220 may filter the records used in the consolidated aggregation value calculation. A filter is an expression that evaluates to a boolean value. The consolidation module 220 may compute the consolidated aggregation value by applying a consolidation function on only the records that evaluate to true. The consolidation module 220 may also group the aggregatable values into groups and compute a consolidated aggregation value for a particular group by applying the consolidation function on the records that belong to that particular group.

In an embodiment, the aggregation function is a function counting the records included in the consolidation time window, for example a COUNT function. The aggregatable values include a value representative of a count of the records included in the extraction time window. For example, the instructions performed by the extraction module 215 could be: {COUNT(num-of-values)}. The consolidated aggregation value is computed by summing the aggregatable values. For example, the instructions performed by the consolidation module 220 could be: Σ COUNT(num-of-values).

In an embodiment, the aggregation function is an average function, for example an AVG function. The aggregatable values comprises a first aggregatable value representative of a count of the records included in the extraction time window, and a second aggregatable value representative of a sum of the values associated with the records included in the extraction time window. For example, the instructions performed by the extraction module 2215 could be: {SUM(values), COUNT(num-of-values)}. The consolidated aggregation value is computed by dividing a sum of the second aggregatable values by a sum of the first aggregatable values. For example, the instructions performed by the consolidation module 220 could be: Σ SUM(values)/(Σ COUNT(num-of-values)).

In an embodiment, the aggregation function is a minimum function of the values of the records included in the consolidation time window, for example a MIN function. The aggregatable values include a minimum of the values associated to the records included in the extraction time window. For example, the instructions performed by the extraction module 215 could be: {MIN(values)}. The consolidated aggregation value is computed by computing the minimum of the aggregatable values. For example, the instructions performed by the consolidation module 220 could be: MIN (MIN(value1), . . . , MIN(valueN)).

In an embodiment, the aggregation function is a minimum function of the values of the records included in the consolidation time window, for example a MAX function. The aggregatable values include a maximum of the values associated to the records included in the extraction time window. For example, the instructions performed by the extraction module 215 could be: {MAX(values)}. The consolidated aggregation value is computed by computing the maximum of the aggregatable values. For example, the instructions performed by the consolidation module 220 could be: MAX (MAX(value1), . . . , MAX(valueN)).

In an embodiment, the aggregation function is a standard deviation function, for example a STDDEV function. The aggregatable values include a first aggregatable value representative of a count of the records included in the extraction time window, a second aggregatable value representative of a sum of the values associated to one of the records included in the extraction time window, and a third aggregatable value representative of a sum of the square of each of the values associated to one of the records included in the extraction time window. For example, the instructions performed by the extraction module 215 could be: {COUNT(num-of-values), SUM(values), SUM(values²)}. The consolidated aggregation value is computed by computing:

√(Σ COUNT(num-of-values)*ΣSUM(values\hat{ }2)−Σ SUM(values)\hat{ }2)/(Σ COUNT(num-of-values)*(Σ COUNT(num-of-values)−1))

### Computer System(s)

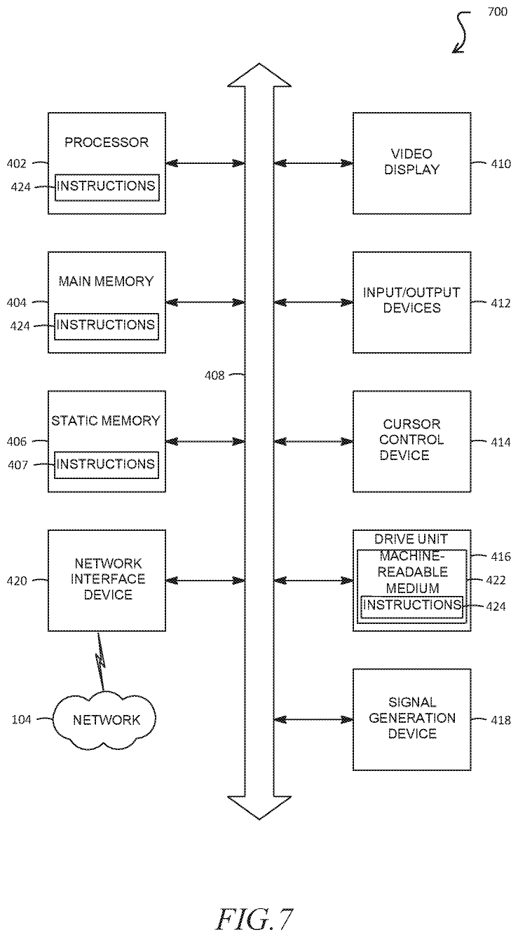

FIG. 7 shows a diagrammatic representation of a machine in the example form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 402 (e.g., a central processing unit (CPU) a graphics processing unit (GPU) or both), a main memory 404 and a static memory 406 (with one or more sets of instructions 407) which communicate with each other via a bus 408. The computer system 700 may further include a video display unit 410 (e.g., a liquid crystal display (LCD) or a cathode ray tube (CRT)). The computer system 700 also includes an alphanumeric input device 412 (e.g., a keyboard), a cursor control device 414 (e.g., a mouse), a disk drive unit 416, a signal generation device 418 (e.g., a speaker) and a network interface device 420.

The disk drive unit 416 includes a non-transitory computer-readable medium 422 on which is stored one or more sets of instructions 424 (e.g., software) embodying any one or more of the methodologies or functions described herein. The instructions 424 may also reside, completely or at least partially, within the main memory 404 and/or within the processor 402 during execution thereof by the computer system 700, the main memory 404 and the processor 402 also constituting non-transitory computer-readable media.

The instructions 424 may further be transmitted or received over a network 104 via the network interface device 420.

While not illustrated, it is understood that that computer system 700 can further include sensors that create data regarding a thermal state of the computer system 700, an orientation of the computer system 700 and a current location of the computer system 700. In various embodiments, the computer system 700 includes a temperature sensor, an accelerometer and/or a global position system for identifying the current location of the computer system 700.

While the non-transitory computer-readable medium 422 is shown in an example embodiment to be a single medium, the term “computer-readable medium” should be taken to include a single medium or multiple media (e.g., a centralized or distributed database, and/or associated caches and servers) that store the one or more sets of instructions. The term “computer -readable medium” shall also be taken to include any medium that is capable of storing, encoding or carrying a set of instructions for execution by the machine and that cause the machine to perform any one or more of the methodologies of the subject matter described herein. The term “computer-readable medium” shall accordingly be taken to include, but not be limited to, solid-state memories, optical and magnetic media, and carrier wave signals.

Thus, a method(s) and system(s) to detect a thermal state(s) and position(s) of a computing device are disclosed herein in accordance with various embodiments. Although the subject matter herein has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer implemented method comprising:
accessing data streams, each data stream including a sequence of records, each record including a record value and a timestamp, and partitioning the data streams according to consecutive extraction time windows;
for each extraction time window:
for each data stream:
computing at least one aggregatable value, the aggregatable value being computed based on the values of the records of the data stream having a timestamp that is included in the extraction time window;
storing the at least one aggregatable value in association with the extraction time window; and
computing a consolidated aggregation value by applying a consolidation function on the aggregatable values stored in association with the extraction time windows included in a consolidation time window.

2. The method of claim 1, wherein the consolidation time window is a rolling time window that includes only one extraction time window.

3. The method of claim 1, wherein the consolidation time window is a sliding time window that includes a fixed number of consecutive extraction time windows.

4. The method of claim 1, wherein the at least one aggregatable value comprises:
a first aggregatable value representative of a count of the records included in the extraction time window; and
a second aggregatable value representative of a sum of the values associated with the records included in the extraction time window;
and wherein the consolidated aggregation value is an average of the values of the records included in the consolidation time window, and is computed by dividing a sum of the second aggregatable values by a sum of the first aggregatable values.

5. The method of claim 1, wherein the at least one aggregatable value includes a minimum of the values associated to the records included in the extraction time window, and wherein the consolidated aggregation value is a minimum of the values of the records included in the consolidation time window and is computed by computing the minimum of the aggregatable values.

6. The method of claim 1, wherein the at least one aggregatable value includes a maximum of the values associated to the records included in the extraction time window, and wherein the consolidated aggregation value is a maximum of the values of the records included in the consolidation time window and is computed by computing the maximum of the aggregatable values.

7. The method of claim 1, wherein the at least one aggregatable value includes a value representative of a count of the records included in the extraction time window, and wherein the consolidated aggregation value is a count of the records included in the consolidation time window and is computed by summing the aggregatable values.

8. The method of claim 1, wherein the at least one aggregatable value includes:
a first aggregatable value representative of a count of the records included in the extraction time window,
a second aggregatable value representative of a sum of the values associated to one of the records included in the extraction time window, and
a third aggregatable value representative of a sum of the square of each of the values associated to one of the records included in the extraction time window; and
wherein the consolidated aggregation value is a standard deviation.

9. A computer system comprising:
a memory to store computer executable instructions;
at least one computer processor coupled to the memory to execute the instruction, that upon execution perform operations comprising:
accessing data streams, each data stream including a sequence of records, each record including a record value and a timestamp, and sampling the data streams according to consecutive extraction time windows;
for each extraction time window:
for each data stream:
computing at least one aggregatable value, the aggregatable value being computed based on the values of the records of the data stream having a timestamp that is included in the extraction time window;
storing the at least one aggregatable value in association with the extraction time window; and
computing a consolidated aggregation value by applying a consolidation function on the aggregatable values stored in association with the extraction time windows included in a consolidation time window.

10. The system of claim 9, wherein the consolidation time window is a rolling time window that includes only one extraction time window.

11. The system of claim 9, wherein the consolidation time window is a sliding time window that includes a fixed number of consecutive extraction time windows.

12. The system of claim 9, wherein the at least one aggregatable value comprises:
a first aggregatable value representative of a count of the records included in the extraction time window; and
a second aggregatable value representative of a sum of the values associated with the records included in the extraction time window;
and wherein the consolidated aggregation value is an average of the values of the records included in the consolidation time window and is computed by dividing a sum of the second aggregatable values by a sum of the first aggregatable values.

13. The system of claim 9, wherein the at least one aggregatable value includes a minimum of the values associated to the records included in the extraction time window, and wherein the consolidated aggregation value is a minimum of the values of the records included in the consolidation time window, and is computed by computing the minimum of the aggregatable values.

14. The system of claim 9, wherein the at least one aggregatable value includes a maximum of the values associated to the records included in the extraction time window, and wherein the consolidated aggregation value is a maximum of the values of the records included in the consolidation time window, and is computed by computing the maximum of the aggregatable values.

15. The system of claim 9, wherein the at least one aggregatable value includes a value representative of a count of the records included in the extraction time window, and wherein the consolidated aggregation value is a count of the records included in the consolidation time window, and is computed by summing the aggregatable values.

16. The system of claim 9, wherein the at least one aggregatable value includes:
a first aggregatable value representative of a count of the records included in the extraction time window,
a second aggregatable value representative of a sum of the values associated to one of the records included in the extraction time window, and
a third aggregatable value representative of a sum of the square of each of the values associated to one of the records included in the extraction time window; and
wherein the consolidated aggregation value is a standard deviation.

17. A non-transitory computer-readable medium storing instructions thereon, which when executed by a processor cause a computer system to perform operations comprising:
accessing data streams, each data stream including a sequence of records, each record including a record value and a timestamp, and sampling the data streams according to consecutive extraction time windows;
for each extraction time window:
for each data stream:
computing at least one aggregatable value, the aggregatable value being computed based on the values of the records of the data stream having a timestamp that is included in the extraction time window;
storing the at least one aggregatable value in association with the extraction time window; and
computing a consolidated aggregation value by applying a consolidation function on the aggregatable values stored in association with the extraction time windows included in a consolidation time window.

18. The computer-readable medium of claim 17, wherein the consolidation time window is a rolling window that includes only one extraction time window.

19. The computer-readable medium of claim 17, wherein the consolidation time window is a sliding window that includes a fixed number of consecutive extraction time windows.

20. The computer-readable medium of claim 17, wherein the at least one aggregatable value comprises:
a first aggregatable value representative of a count of the records included in the extraction time window; and
a second aggregatable value representative of a sum of the values associated with the records included in the extraction time window;
and wherein the consolidated aggregation value is computed by dividing a sum of the second aggregatable values by a sum of the first aggregatable values; and
wherein the consolidated aggregation value is an average of the values of the records included in the consolidation time window.
